(19) United States
(12) Patent Application Publication
(10) Pub. No.: US 2003/0124893 A1
(43) Pub. Date: Jul. 3, 2003

(54) Electrical safety outlet

(76) Inventor: James A. Campbell, Martensdale, IA (US)

Correspondence Address: Russell W. Baugh, RBCO, L.L.C., 1030 Aspen Drive, Norwalk, IA, 50211, US

(21) Appl. No.: 10/035,740

(22) Filed: Dec. 28, 2001

(51) Int. Cl. H01R 29/00

(52) U.S. Cl. 439/188

(57) ABSTRACT

An electrical outlet, having two or more contact slots, includes one or more switches associated with the contact slots. Electricity does not flow to the contact arms in the slots until all of the switches are moved into an on position. The switch(es) may not be moved into an on position unless the contact slots are properly accessed, such as occurs with the use of a conventional electrical plug. The switch(es) may be of any variety, including mechanical, optical, magnetic, proximity, etc.

### BACKGROUND OF THE INVENTION

1. Field of the Invention

The present invention relates generally to an electrical outlet, and more particularly, though not exclusively, to an electric outlet that minimizes the risk of shock by incorporating a safety switch that provides an electrical connection after being properly engaged by a conventional electrical plug.

2. Problems in the Art

Currently, most households receive electricity from an outside source such as a power plant's generator. This electricity is typically transmitted in the form of an alternating current over an electrical grid and into a home. Inside the home, the electrical power is routed to several sockets on electrical outlets that allow users to power various devices, such as lamps, televisions, vacuums, etc. The electricity supplied to the electrical outlets in the home typically has a maximum voltage of 170 volts, an RMS voltage of 120 volts, and a frequency of 60 Hz. This is more than sufficient to kill or seriously injure a human being.

Because of the risk of severe injury or death from inadvertent or accidental contact with electricity, a variety of precautions and safety measures have already been taken. For instance, there are several varieties of outlet covers or socket inserts available today. Outlet covers and socket inserts are typically used to prevent small children from accessing the sockets and accidentally touching the potentially deadly electrical contact arms therein.

Unfortunately, outlet covers and socket inserts are not fail proof. They may be inadvertently removed or bypassed, giving a curious child access to one or more of the electrical contacts. Human contact with even one of the electrical contact arms may have potentially devastating consequences.

Further, outlet covers and socket inserts are inconvenient to use. Many get lost or broken and must frequently be replaced. Outlet covers and socket inserts also make access difficult for even proper use. Therefore, it is desirable to provide an electrical outlet with a safety feature that is both convenient to use and difficult to remove.

Additional attempts to improve the safety of electrical outlets, by minimizing the effects of any shock received, have also been made. Many outlets now include devices, such as a ground fault circuit interrupter (GFCI), that cut the flow of electricity if an imbalance, such as occurs during a shock, in the flow occurs. While these devices significantly reduce the chances of serious injury, an initial shock still occurs. This initial shock occurs because the power supplied to electrical outlets is generally always available. There is therefore a need for a safety device that limits the availability of electrical power from an outlet.

### FEATURES OF THE INVENTION

A general feature of the present invention is the provision of an electrical outlet which overcomes the problems found in the prior art.

A further feature of the present invention is the provision of an electrical outlet that is convenient to use.

Another feature of the present invention is the provision of an electrical outlet that incorporates safety features which are difficult to remove.

A further feature of the present invention is the provision of an electrical outlet that minimizes the chance of shock from accidental contact with one of the electrical contacts.

A still further feature of the present invention is the provision of an electrical outlet that limits the availability of electricity.

These, as well as other features and advantages of the present invention, will become apparent from the following specification and claims.

### SUMMARY OF THE INVENTION

The present invention generally comprises an electrical outlet that incorporates a safety switch. The present invention includes a switch that limits the availability of electricity. Any type of switch may be used, including lever actuators, roller switches and other mechanical switches. Further, sensor type switches may be used, including optical sensors, magnetic sensors, etc. One sensor may be used per socket or per contact slot.

### BRIEF DESCRIPTION OF THE DRAWINGS

FIG. 1 is a pictorial representation of a typical electrical outlet and conventional electrical plug.

FIG. 2 is an internal view of one embodiment of the safety outlet of the present invention.

FIG. 3 is an internal view of one embodiment of the safety outlet of the present invention in the off position.

FIG. 4 is an internal view of one embodiment of the safety outlet of the present invention in the on position.

FIG. 5 is an internal view of a second embodiment of the safety outlet of the present invention.

FIG. 6 is an internal view of accidental contact with one of the conducting arms of the second embodiment of the safety outlet of the present invention.

FIG. 7 is an internal view of proper contact with both of the conducting arms of the second embodiment of the safety outlet of the present invention.

### DETAILED DESCRIPTION OF THE PREFERRED EMBODIMENT(S)

The present invention will be described as it applies to its preferred embodiment. It is not intended that the present invention be limited to the described embodiment. It is intended that the invention cover all modifications and alternatives which may be included within the spirit and scope of the invention.

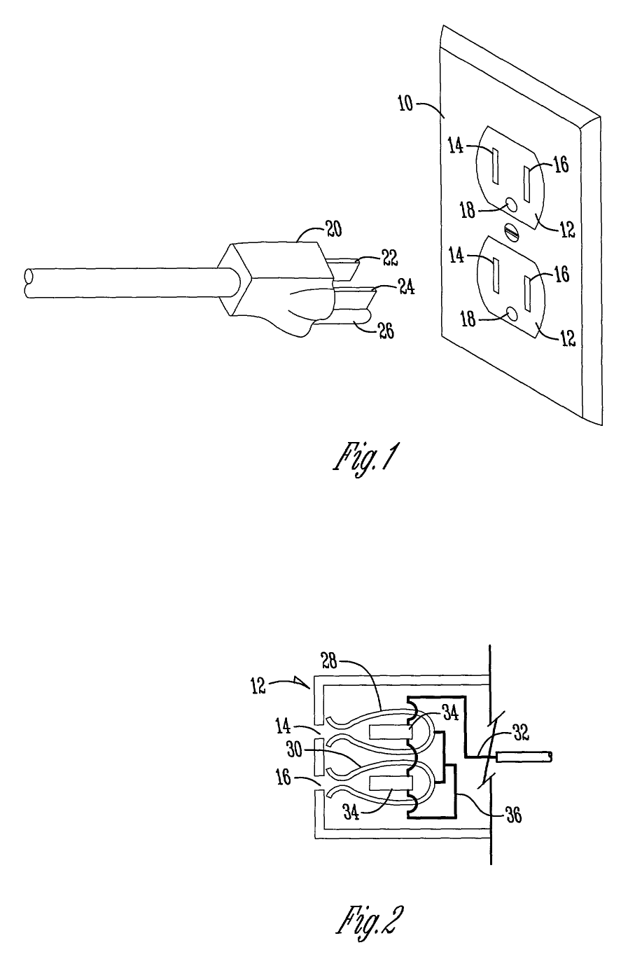

As shown in FIG. 1, the safety outlet 10 of the present invention appears similarly to a typical electrical outlet. The outlet 10 has any number of sockets 12 each having a first contact slot 14, second contact slot 16, and a ground slot 18. A conventional electrical plug 20 is also shown. The plug 20 usually includes a first blade prong 22 and a second blade prong 24. The plug 20 may also include a third cylindrical prong 26 for a ground connection. All of the prongs 22, 24, and 26 fit into the corresponding slots 14, 16 and 18 on the socket 12 in the outlet 10.

The preferred embodiment of the invention is shown in FIG. 2. A first electrical contact arm 28 is in the first slot 14. A second electrical contact arm 30 is in the second slot 16. Typically these arms are made of copper or another conductive substance and separated from one another by a piece of plastic or other non-conductive substance. Power is supplied to the electrical contact arms 28 and 30 by an electrical power wire or cable 32. Preferably, a switch 34 is associated with each slot 14 and 16. Additional switches may also be associated with any other slots, including slot 18.

Each switch 34 has an on and off position. In the on position, electrical current will be permitted to pass. In the off position, no electrical current will pass and the contact arms 28 and 30 will be dead. Therefore any accidental contact with either of the contact arms 28 and 30 will not be harmful. Further, since the switch 34 is in the outlet itself, removal is extremely difficult.

The switches 34 may be of any type, including mechanical switches such as lever actuators, roller switches, push button switches, rotary switches, etc. Optical, magnetic, or proximity sensors may also be used if the sensor(s), used herein as equivalent to a switch, is properly positioned. The operability and installation of any of the above switches is well known in the art. Any necessary connecting wire 36 is used to connect each of the switches 34 such that both must be in the on position before any electricity will flow to either of the contact arms 28 and 30. Both of the switches 34 will be moved into the on position by simply inserting a conventional plug 20 into the slots 14 and 16. As there are no parts to remove before a conventional electrical plug 20 may be inserted, the present invention is very convenient to use.

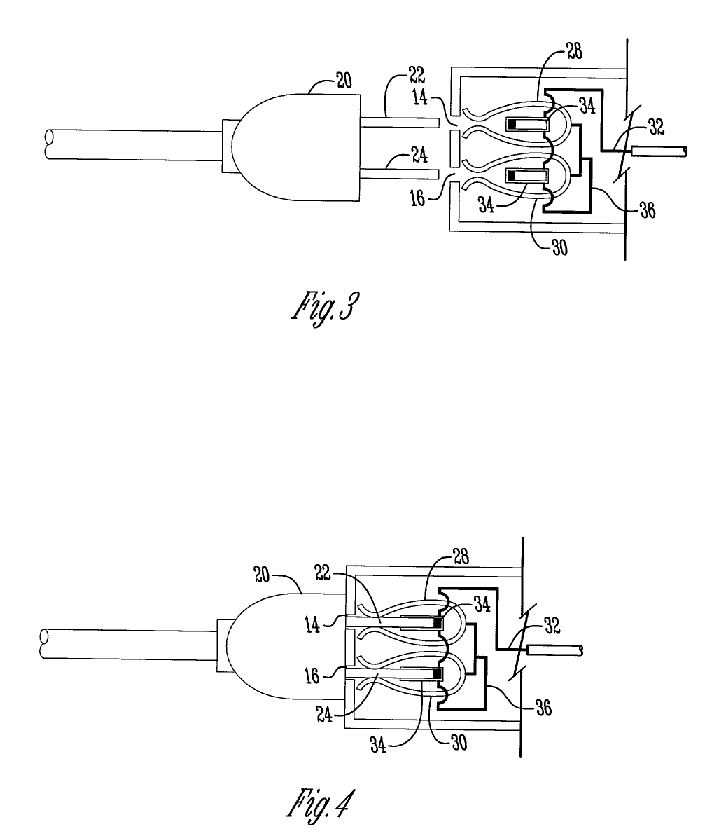

A simple mechanical switch is shown in FIGS. 3 and 4. Before a conventional electrical plug 20, including blade prongs 22 and 24, is inserted into the outlet 10, the switches 34 are in an off position as is shown in FIG. 3. After the plug 20 is properly inserted, both of the switches 34 have been moved to their on position and electricity will flow to the conducting arms 28 and 30 and into the prongs 22 and 24, shown in FIG. 4.

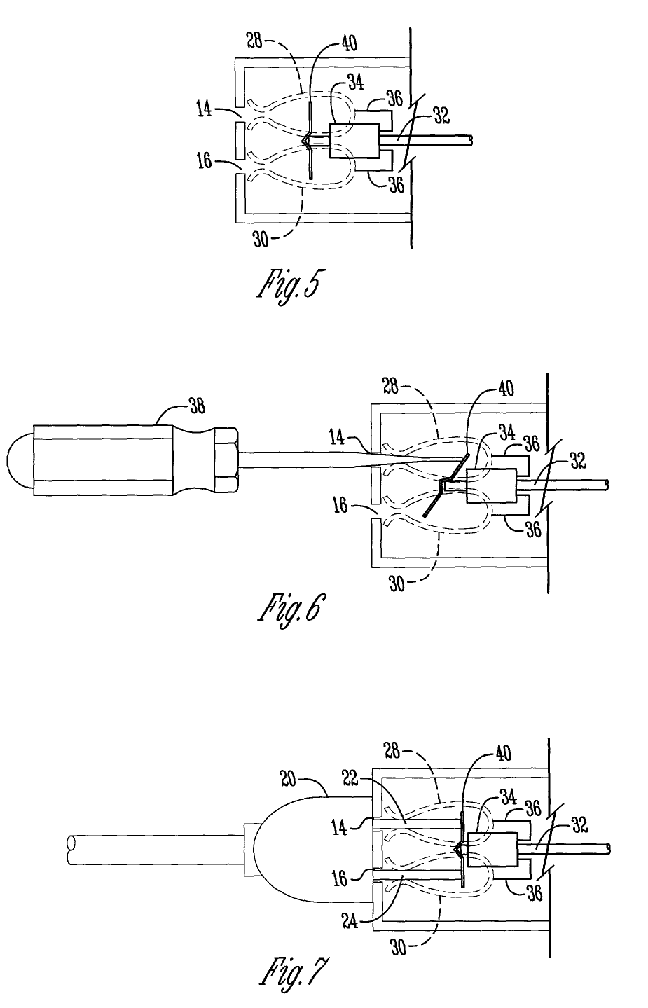

Another embodiment of the invention is shown in FIGS. 5, 6, and 7. In this embodiment, a single switch 34 is used. However, the switch 34 has a pivotal head 40 or other mechanism that protrudes into both slots 14 and 16. As is shown in FIG. 5, when the switch 34 is fully extended, it is in the off position and no electricity flows to either contact arm 28 or 30. Typically, a curious child will use a fork, stick or other object to poke at one of the slots 14 or 16.

FIG. 6 illustrates that when an object, such as the screwdriver 38 shown, is inserted into only one of the slots 14 or 16, the switch 34 remains in the off position. When an object such as the plug 20 is properly inserted into both slots 14 and 16, the switch 34 is moved into the on position and electricity will begin to flow to the contact arms 28 and 30 and into the prongs 22 and 24 as is shown in FIG. 7. In this manner, no electricity is available at the contact arms 28 or 30 unless the slots 14 and 16 are properly accessed, thereby minimizing the risk of shock from accidental contact with either of the contact arms 28 or 30 individually.

A general description of the present invention as well as a preferred embodiment of the present invention has been set forth above. Those skilled in the art to which the present invention pertains will recognize and be able to practice additional variations in the methods and apparatus described which fall within the teachings of this invention. For example, the present invention contemplates numerous variations in the size and shape of the plug and prongs as may be appropriate for a particular voltage or frequency of an AC source or as may be otherwise appropriate or desirable for a particular context or environment. Accordingly, all such modifications and additions are deemed to be within the scope of the invention which is to be limited only by the claims appended hereto.

What is claimed is:

1. A safety outlet for providing an electrical connection to a conventional electrical plug, the outlet comprising:
a socket for receiving a prong on an electrical plug; and
a switch movable between on and off positions by insertion or removal of the prong in the socket.

2. The safety outlet of claim 1 wherein the socket includes two or more contact slots and the switch is moveable to an on position only upon insertion of a prong into each of the contact slots.

3. The safety outlet of claim 1 wherein the switch is a proximity sensor.

4. The safety outlet of claim 1 wherein the switch is a mechanical switch.

5. The safety outlet of claim 1 wherein the switch is an optical sensor.

6. A safety outlet for providing an electrical connection, the outlet comprising:
a socket having a first contact slot and a second contact slot;
a first switch movable between an on and off position upon insertion or removal of any object in the first contact slot;
a second switch being movable between an on and off position upon insertion or removal of any object in the second contact slot; and
wherein an electrical connection is established only if the first switch and the second switch are both in the on position.

7. The safety outlet of claim 6 furhter comprising a source of electrical energy electrically connected to the first switch and the second switch for providing approximately 120V Ac at approximatley 60 Hz.

8. A method of establishing an electrical connection from an outlet while reducing the chance of electrical shock, the method comprising:
installing an electrical outlet having a socket for receiving a prong on an electrical plug and a switch moveable between on and off positions by insertion or removal of the prong;
inserting the prong into the socket; and
moving the switch to an on position to establish an electrical connection.

9. The method of establishing an electrical connection of claim 7 wherein the socket includes a first contact slot and a second contact slot, the plug includes a first prong and a second prong and the switch is moveable to an on position only upon insertion the first prong into the first contact slot and the second prong into the second contact slot.
